(19) United States
(12) Patent Application Publication
(10) Pub. No.: US 2011/0079302 A1
(43) Pub. Date: Apr. 7, 2011

(54) Pump Valve with Full Elastomeric Contact on Seat

(75) Inventor: John E. Hawes, Southlake, TX (US)

(73) Assignee: Weir SPM, Inc., Fort Worth, TX (US)

(21) Appl. No.: 12/900,146

(22) Filed: Oct. 7, 2010

Related U.S. Application Data
(60) Provisional application No. 61/249,367, filed on Oct. 7, 2009.

(51) Int. Cl. F16K 25/00; F16K 17/04; F16K 1/32

(52) U.S. Cl. 137/538; 251/359; 251/368

(57) ABSTRACT

This invention relates to valve assemblies having a valve seat body having an axial bore therethrough; wherein the valve seat body has an inclined seat surface located on an upper end of the seat body. The valve assemblies further include a valve member having a valve body such that the valve body is positioned within the axial bore of the valve seat body. A seal is disposed between the seat surface of the seat body and an annular seal surface of the valve member such that the seal prevents contact between the seat surface of the seat body and the valve member.

### Field of the Invention

This invention relates in general to valves for reciprocating oilfield pumps, and in particular to a valve member having full elastomeric contact with a valve seat.

### BACKGROUND OF THE INVENTION

Various kinds of pumps are used in oilfield operations. One type of pump, for example, is a reciprocating pump. The reciprocating pump can be used to pump fluid such as chemicals, cement, mud, or other media into a wellbore. Reciprocating pumps typically increase the pressure within a cylinder by reciprocating a plunger longitudinally within the cylinder. Packing is generally used around the plunger and the plunger reciprocates as a crankshaft located within the pump rotates. As the plunger moves away from the cylinder, the pressure of the fluid inside chamber decreases creating a differential pressure across an inlet valve that allows the fluid to enter the cylinder. As plunger moves longitudinally towards the cylinder, the pressure of the fluid inside of the cylinder increases until the differential pressure across an outlet valve that allows fluid to exit cylinder.

Reciprocating pumps are typically exposed to highly abrasive fluids, and high pressures, which can result in wear on valve surfaces. Valve bodies typically incorporate an seal within a peripheral seal retention groove.

Metal fatigue is induced when cyclical high pressure is applied to a valve body sealed against, and being distorted by, a web seat. The pressure tends to repeatedly force the disc-shaped area of the valve body (i.e., the flange) into the spaces between the seat webs. This distortion, plus impact loads secondary to valve closure and bending moments caused by pressure on the valve seal, causes non-uniform stresses in the flange, particularly in the two opposing walls of the flange's peripheral seal retention groove.

Because of high pump pressures (up to about 15,000 psi) that the valves experience and the abrasive solid particles suspended in drilling mud and other fluids, valves and valve seats typically wear at a very rapid rate and must be replaced frequently. One of the most significant points of impact stress in the valve assembly is the point of contact of the valve body and the valve seat body. The extremely high differential pressures in the valve cause the conical portion of the valve body to engage the valve seat with a very high impact. The repetitive impact eventually causes the faces of the valve body and the valve seat to become worn and pitted. Thus, there is a need for an improved valve seat which reduces the impact stress related to the impact of the valve body with the valve seat.

### SUMMARY OF THE INVENTION

In one embodiment, a valve assembly is provided. The valve assembly includes a valve seat body having an axial bore therethrough. The valve seat body includes an inclined seat surface located on an upper end of the seat body. The assembly includes a valve member having a valve body such that the valve body is positioned within the axial bore of the valve seat body. The assembly further includes a seal disposed between the seat surface of the seat body and an annular seal surface of the valve member such that the seal prevents contact between the seat surface of the seat body and the valve member.

In certain embodiments, the annular seal surface of the valve member further includes an annular recess at the inner and outer diameter of the seal surface. In certain embodiments, the seal includes a thicker portion at the outer and inner diameter of the seal, wherein the thicker portions of the seal are positioned within the annular recess of the annular seal surface.

In alternate embodiments, the valve seat body further includes an annular recess at the inner and outer diameter of the seal surface. The seal can include a thicker portion at the outer and inner diameter of the seal, wherein the thicker portions of the seal can be positioned within the annular recess of the annular seal surface.

In another embodiment, a valve assembly is provided. The valve assembly including a valve seat body having an axial bore therethrough. The valve seat body having an inclined seat surface located on an upper end of the seat body. The assembly includes a valve member having a valve body such that the valve body is positioned within the axial bore of the valve seat body, and the valve body includes an annular seal surface. The assembly includes a first seal formed into the seat surface of the valve seat body, wherein the first seal covers the seat surface of the valve seat body. The first seal is disposed between the seat surface of the seat body and an annular seal surface of the valve member preventing contact between the seat surface of the seat body and the valve member.

In another embodiment, a valve assembly is provided. The valve assembly includes a valve seat body having an axial bore therethrough; wherein the valve seat body has an inclined seat surface located on an upper end of the seat body. The assembly further includes a valve member having a valve body such that the valve body is positioned within the axial bore of the valve seat body. The valve body includes an annular seal surface having a cavity formed around said annular seal surface. The assembly further includes a seal positioned in the cavity formed around the annular seal surface such that the seal is disposed between the seat surface of the seat body and an annular seal surface of the valve member preventing contact between the seat surface of the seat body and the valve member.

### BRIEF DESCRIPTION OF THE DRAWINGS

FIG. 1 is a sectional view of a valve assembly constructed in accordance with an embodiment of the invention.

FIG. 2 is a quarter sectional view of an alternate embodiment of a valve assembly in accordance with an embodiment of the invention.

FIG. 3 is a quarter sectional view of another alternate embodiment of a valve assembly in accordance with an embodiment of the invention.

FIG. 4 is a sectional view of another alternate embodiment of a valve assembly in accordance with an embodiment of the invention.

### DETAILED DESCRIPTION OF THE INVENTION

As used herein, a “valve assembly” suitable for abrasive fluids, such as oil field drilling mud, includes a valve body (the moving element) and a corresponding valve seat.

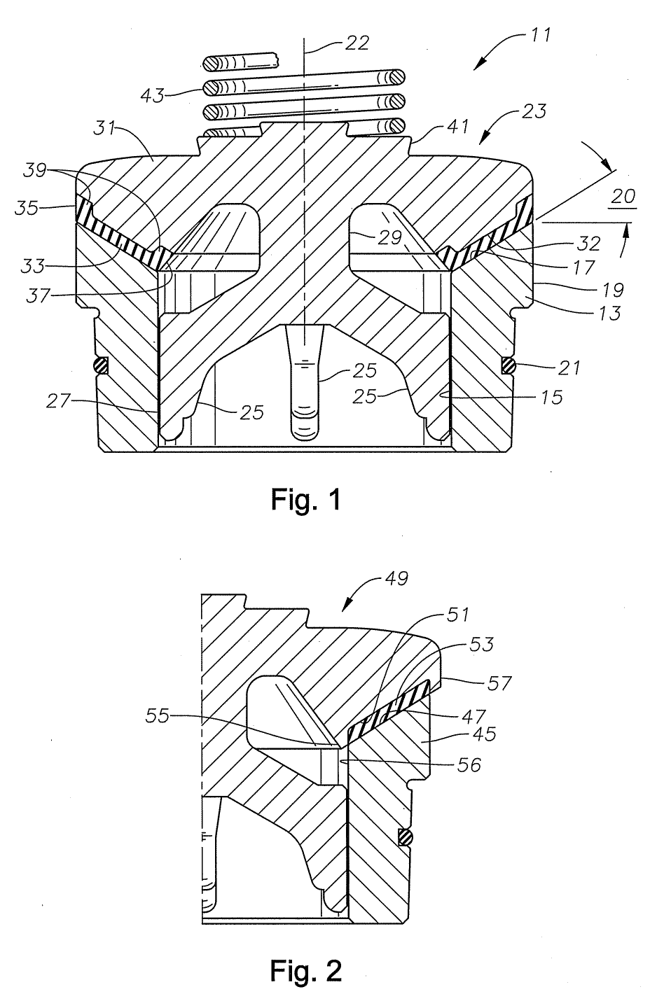

Referring to FIG. 1, valve assembly 11 is of a type of valve which is suitable to be installed with a reciprocating pump (not shown), particularly a large, high pressure pump for oilfield applications, such as hydraulic fracturing. In hydraulic fracturing operations, the pump pumps fracturing fluid into a wellbore at a high pressure. Valve assembly 11 includes a seat body 13 that mounts within a manifold of the pump. Seat body 13 is a tubular member typically formed of metal, such as cast steel. Seat body 13 has an axial bore 15. An inclined seat surface 17 is located on the upper end of seat body 13. Seat surface 17 is a conical surface extending from bore 15 to an outer diameter portion 19 of seat body 13. The conical contour of seat surface 17 is at a single angle 20, thus appears straight when viewed in cross section as in FIG. 1. Angle 20 is relative to a plane that is perpendicular to an axis 22 of bore 15. Angle 20 may be conventional, which is typically from about 30° to 45°, or it may differ from the prior art, as will be explained subsequently in connection with FIG. 4. Seat body 13 has an annular seal 21 around its exterior for mounting within a flow passage of the pump such that in certain embodiments, the annular seal prevents metal-to-metal contact between the seat body and valve member 23.

Valve member 23 operates between an open and closed position in response to differential pressure. Valve member 23 can have plurality of legs 25, of which three are shown in this example. Legs 25 have outer ends 27 that slide against the side wall of bore 15. Legs 25 are secured to a central stem 29, which extends upward along axis 22 to a valve body 31. Valve body 31 flares radially outward from stem 29 and has a downward and outward-facing annular seal surface 32 at its outer diameter. A seal 33 is bonded to and completely covers annular seal surface 32 such that when valve member 23 is disposed in seat body 13 there is no metal-to-metal contact between seat surface 17 and annular seal surface 32. Seal 33 is preferably molded in place on surface 32, but in certain embodiments, it could be a pre-formed seal that is installed in other manners. Seal 33 can be foamed of a suitable thermoplastic material which may be conventional. For example, in one embodiments, seal 33 may be a urethane material. In certain embodiments, seal 33 can include fiber reinforcement disposed within the seal, such as carbon, glass, cotton, wire fibers, or combinations thereof, which can be either randomly disposed or purposely oriented with respect to the seal surface. In alternate embodiments, seal 33 can include a cloth disposed within the thermoplastic material, wherein the cloth can include carbon, glass, wire, cotton fibers, or combinations thereof. The fiber reinforcement can be flat woven fabrics or fiber webs that can include fiber bundles having a great number of individual fibers. Fiber reinforcement, in some embodiments, can prevent or reduce delamination at the interfaces. In some embodiments, seal 33 can have a hardness of 95A durometer or greater. For example, seal 33 can have a hardness of 60D durometer or more. Valve body 31 is normally much harder and more rigid than the material of seal 33. Valve body 31 may be formed of a cast steel of the same type as seat body 13.

Seal 33 extends completely across annular seal surface 32 from an outer diameter 35 of valve body 31 to an inner diameter 37 of seal surface 32, thereby preventing contact between seat body 13 and valve member 23. Seal 33 may have substantially uniform thickness, but in the embodiment shown in FIG. 1, the seal has thicker portions 39 at the outer diameter 35 and inner diameter 37 to help retain seal 33 in place. The thicker portions 39 of seal 33 are located within annular recesses or cavities at the outer diameter 35 and inner diameter 37 of valve body annular seal surface 32. Seal 33 completely prevents any portion of valve body 31 from contacting valve seat surface 17. Seal 33 has a conical engaging face formed at the same angle 20 and preferably has the same area as valve seat surface 17. The inner diameter of seal 33 coincides with bore 15, and the outer diameter of seal 33 coincides with seat body outer diameter portion 19.

Valve body 31 has a boss 41 on its upper end that is coaxial with axis 22. A coiled spring 43 engages boss 41 and is compressed against a portion of the manifold housing of the pump. During operation, differential pressure on valve body 31 will cause it to further compress coiled spring 43 and lift from seat surface 17. This movement opens bore 15 for fluid to flow out between seal 33 and seat surface 17. At the end of the stroke, coiled spring 43 overcomes the differential pressure and forces valve member 31 back into contact with seat surface 17, as shown in FIG. 1.

Referring to FIG. 2, in this embodiment, seat body 45 is constructed in the same manner as seat body 13 of the first embodiment (and shown in FIG. 1). Seat body 45 has a conical seat surface 47 on its upper end. Valve body 49 differs in that an annular cavity 51 is formed around its seat engaging portion. Elastomeric seal 53 is cast in place within cavity 51. Cavity 51 does not extend fully to the inner and outer diameters of valve body 49, resulting in a metal inner wall portion 55 on the inner diameter and a metal outer wall portion 57 on the outer diameter. The lower edges of inner and outer wall portions may be substantially flush with the lower surface of seal 53. However, the lower edges of inner wall portion 55 and outer wall portion 57 do not contact seat surface 47. The lower edge of inner wall portion 55 is located radially inward from the side wall of bore 56 of seat body 45. The lower edge of outer wall portion 57 is located radially outward from the outer diameter of seat surface 47. Preferably, seal 53 has the same surface area as seat 47. The inner diameter of seal 53 is located at inner diameter bore 56. The outer diameter of seal 47 is located at the outer diameter of seat surface 47.

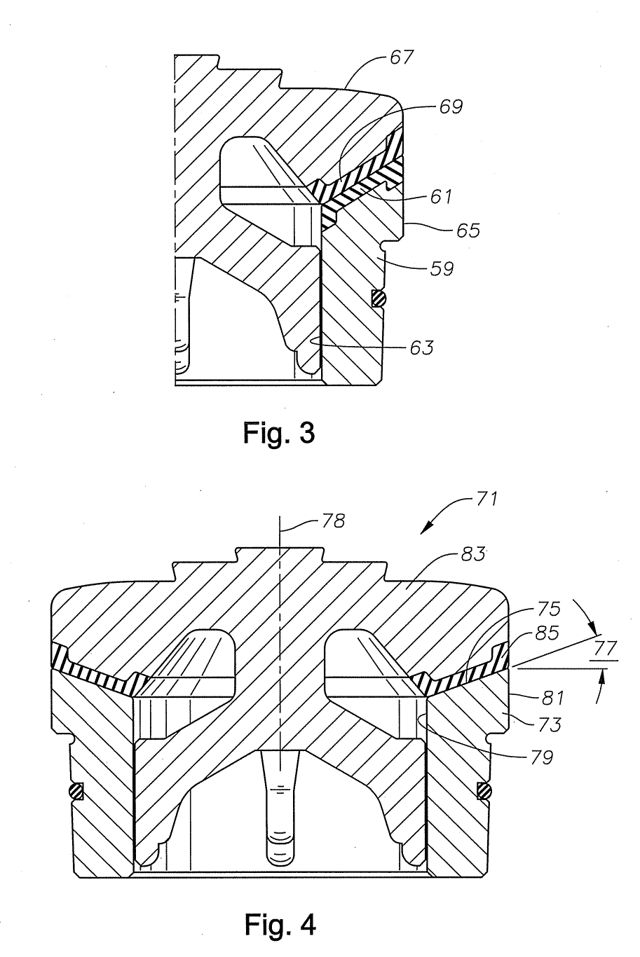

FIG. 3 discloses another embodiment of a valve assembly. In this embodiment, seat body 59 differs from seat bodies 13 and 45. Seat body 59 has a seat seal 61 foamed on its seat surface. Seat seal 61 may be of the same thermoplastic material as utilized for the valve member seals 33 and 53 of FIGS. 1 and 2. Seat seal 61 preferably extends from the bore 63 to an outer diameter portion 65, thus completely covering any metal on the seat surface of seat body 59. Valve member 67 of the embodiment of FIG. 3 may be the same as valve body 31 of FIG. 1 or valve body 49 of FIG. 2. In this example, it is the same as FIG. 1. Valve member 67 has a seal 69 that extends completely across and is coextensive with seat seal 61. However, seal 69 on valve member 67 could be eliminated.

Referring to FIG. 4, in this embodiment, valve assembly 71 has a seat body 73 with a seat surface 75 formed at a different angle than the angles of the seats in the first three embodiments. In this embodiment, angle 77 is preferably much less relative to a plane perpendicular to axis 78 than angle 20 of FIG. 1. In certain embodiments, angle 77 is preferably about 15-25°. Because angle 77 is less, the conical seat surface 75 will have less surface area than in the other embodiments. Seat surface 75 is preferably formed at a single conical angle and extends from bore 79 to outer diameter portion 81 of seat body 73.

Valve member 83 may be the same as provided in FIG. 1 or in FIG. 2. In this example, it is the shown to be the same as in FIG. 1, except for the angle of its seal 85. The angle of its seal 85 is the same as angle 77. The smaller angle 77 provides more efficiency in that for a given increment of upward movement of valve member 83, the opening between seal 85 and seat 75 will be greater than if angle 77 were larger. That advantage is offset to some extent by having lesser surface area of seat surface 75.

A variety of different valve members, including those that do not have legs 25 (as shown, for example, in FIG. 1) may be employed, in addition to those valve members that are shown in the figures. Also, although in each of the embodiments the angle of the seat and the angle of the valve member seal surface are the same, those angles could differ from each other slightly.

In certain embodiments, the valve assemblies described herein are configured to operate in the presence of highly abrasive fluids, such as drilling mud, at high pressures, for example up to about 15,000 psi. While the valve assemblies described herein have been discussed with respect to use in pumps, for example, reciprocating pumps, it is understood that many other applications for said valve assemblies lie within the scope of the invention.

In certain embodiments, the valve assemblies described herein are suitable for use with pumps contemplated for use with oil and gas well service operations, such as pumping high pressure fluid into a well to hydraulically fracture the well. The pumps may also be configured for pumping drilling fluid into the well bore during drilling. In certain embodiments, the pump can be a reciprocating pump having a power source connected to a pinion gear, such as an electrical motor or diesel engine,. The gear drives a bull gear, which is connected to a crankshaft. Several connecting rods having aft ends can be rotatably mounted to the crankshaft. The terms “aft” and “forward” are used herein for convenience only, not in a limiting manner.

Each connecting rod can have a forward end that is connected to a crosshead. Each crosshead strokes linearly within a stationary crosshead case, which can be mounted to the pump frame. A pony rod secures to the forward end of each crosshead, and a plunger connects to the forward end of the pony rod by a clamp. The power end of the pump causes the plunger to stroke linearly within a cylinder in a fluid end block. Each cylinder has an access cover secured to the fluid end block for inserting and withdrawing one of the plungers. Tie rods connect the fluid end block to the aft end portion of pump. As the plunger strokes, fluid is brought into the chamber in the forward end from intake and discharged at higher pressure out a discharge (not shown). Intake and discharge valves open and close to draw fluid in and discharge fluid from the chamber. Reciprocating pumps are described, for example, in U.S. patent application Ser. No. 12/821,663, the disclosure of which is hereby incorporated by reference in its entirety.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

As is understood in the art, not all equipment or apparatuses are shown in the figures. For example, one of skill in the art would recognize that various holding tanks and/or pumps may be employed in the present method.

The singular forms “a”, “an” and “the” include plural referents, unless the context clearly dictates otherwise.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

Throughout this application, where patents or publications are referenced, the disclosures of these references in their entireties are intended to be incorporated by reference into this application, in order to more fully describe the state of the art to which the invention pertains, except when these references may include statement that contradict the statements made herein.

As used herein, recitation of the term about and approximately with respect to a range of values should be interpreted to include both the upper and lower end of the recited range.

We claim:

1. A valve assembly comprising:
a valve seat body having an axial bore therethrough;
said valve seat body having an inclined seat surface located on an upper end of the seat body;
a valve member having a valve body such that the valve body is positioned within the axial bore of the valve seat body;
a seal disposed between the seat surface of the seat body and an annular seal surface of the valve member such that the seal prevents contact between the seat surface of the seat body and the valve member.

2. The valve assembly of claim 1 wherein said valve assembly is configured to be installed in a reciprocating pump.

3. The valve assembly of claim 1 wherein the seal comprises a thermoplastic material.

4. The valve assembly of claim 1 wherein the seal comprises a urethane.

5. The valve assembly of claim 1 wherein the seal comprises fiber reinforcement disposed therein.

6. The valve assembly of claim 5 wherein the fiber is selected from the group consisting of carbon fibers, glass fibers, cotton fibers, wire fibers, and combinations thereof.

7. The valve assembly of claim 1 wherein the annular seal surface of the valve member further comprises an annular recess at the inner and outer diameter of the seal surface.

8. The valve assembly of claim 7 wherein the seal comprises a thicker portion at the outer and inner diameter of the seal, wherein the thicker portions of the seal are positioned within the annular recess of the annular seal surface.

9. The valve assembly of claim 1 wherein the valve seat body further comprises an annular recess at the inner and outer diameter of the seal surface.

10. The valve assembly of claim 9 wherein the seal comprises a thicker portion at the outer and inner diameter of the seal, wherein the thicker portions of the seal are positioned within the annular recess of the annular seal surface.

11. The valve assembly of claim 1 wherein the seat surface of the valve seat body is at an angle of between about 30° and 45° relative to a plane that is perpendicular to the axis of the valve seat body.

12. The valve assembly of claim 1 wherein the seat surface of the valve seat body is at an angle of between about 15° and 25° relative to a plane that is perpendicular to the axis of the valve seat body.

13. A valve assembly comprising:
a valve seat body having an axial bore therethrough;
said valve seat body having an inclined seat surface located on an upper end of the seat body;
a valve member having a valve body such that the valve body is positioned within the axial bore of the valve seat body, said valve body including an annular seal surface;
a first seal formed into the seat surface of the valve seat body, said first seal covering the seat surface of the valve seat body;
wherein the first seal is disposed between the seat surface of the seat body and an annular seal surface of the valve member preventing contact between the seat surface of the seat body and the valve member.

14. The valve assembly of claim 13 further comprising a second seal positioned in a cavity formed in the annular seal surface of the valve member, wherein said second seal is disposed in having a cavity formed around said annular seal surface and contacts the first seal.

15. The valve assembly of claim 13 wherein the annular seal surface of the valve member further comprises an annular recess at the inner and outer diameter of the seal surface, and said second seal further comprises thicker portions at the inner and outer diameter of the seal such that the thicker portions of the second seal engage the annular recess at the inner and outer diameter of the seal surface.

16. The valve assembly of claim 13 wherein the valve assembly is configured to be located within a reciprocating pump.

17. A valve assembly comprising:
a valve seat body having an axial bore therethrough;
said valve seat body having an inclined seat surface located on an upper end of the seat body;
a valve member having a valve body such that the valve body is positioned within the axial bore of the valve seat body, said valve body including an annular seal surface having a cavity formed around said annular seal surface;
a seal positioned in the cavity formed around the annular seal surface such that the seal is disposed between the seat surface of the seat body and an annular seal surface of the valve member preventing contact between the seat surface of the seat body and the valve member.
